(19) United States
(12) Patent Application Publication
(10) Pub. No.: US 2020/0346985 A1
(43) Pub. Date: Nov. 5, 2020

(54) PROCESS FOR PRODUCING AN AMMONIUM NITRATE OR CALCIUM AMMONIUM NITRATE FERTILIZER GRANULATE AND FERTILIZER GRANULATES PRODUCED THEREBY

(71) Applicants: thyssenkrupp Industrial Solutions AG, Essen (DE); thyssenkrupp AG, Essen (DE)

(72) Inventors: Helmut GEHRKE, Bergkamen (DE); Stefan HELMLE, Hamm (DE); Sven RÜSCHHOFF, Beckum (DE); Thorsten WIEMUTH, Paderborn (DE)

(73) Assignees: thyssenkrupp Industrial Solutions AG, Essen (DE); thyssenkrupp AG, Essen (DE)

(21) Appl. No.: 16/765,241

(22) PCT Filed: Dec. 3, 2018
(86) PCT No.: PCT/EP2018/083276

§ 371 Date: May 19, 2020

(30) Foreign Application Priority Data
Dec. 4, 2017 (DE) 10 2017 221 789.8

(51) Int. Cl. C05C 1/02; C05G 5/12; C05C 3/00

(52) U.S. Cl. CPC C05C 1/02; C05C 3/005; C05G 5/12

(57) ABSTRACT

A method may be employed to produce a fertilizer granulate comprising an ammonium salt and, as a filler material, limestone, dolomite, and/or magnesite. At least a proportion of the limestone or dolomite or magnesite is at least partially calcinated prior to use in the fertilizer granulate. A targeted adjustment of the reactivity of the filler material may occur by its degree of calcination and/or its calcite proportion. If, for example, dolomite is used as a filler material, the calcination results in separation of carbon dioxide from the mineral. This calcination is a two-stage process in which the dolomite is first converted to periclase (MgO) and calcite (CaCO3), and the calcite is also converted by decomposition and release of carbon dioxide only at a higher temperature.

The present invention relates to a method for producing a fertilizer granulate comprising at least one ammonium salt and also limestone and/or dolomite as a filler material, wherein at least a proportion of the limestone or dolomite is at least partially calcined prior to use in the fertilizer granulate.

The large-scale production of fertilizers has given rise to an important branch of industry today. The reasons for this lie in the continuing increase in world population, and also in an accompanying increase in the need for cultivated farmland. Intensive cultivation of the fields removes basic useful materials that are essential for plant growth.

Substances to be seen as essential for plant growth include nitrogen, phosphorus and sulfur compounds, which are usually presented in the form of compounds comprising ammonium and/or nitrate and/or sulfate and/or phosphate and also partially a number of further components. A wide variety of methods for producing such fertilizers are known to the person skilled in the art, and these should therefore be mentioned only by way of example:

In drum granulation, solutions, melts, or suspensions are placed on an existing particle bed, enclosed for example by a hot air flow, resulting both in a reduction of the water content and solidification of the applied material, which gives rise to growth of the granulates contained in the particle bed.

In prilling, a melt is pressed or dripped through fine openings and cooled in a countercurrent e.g. with air, resulting in crystallization of the material contained in the melt. This process takes place in so-called prilling towers, wherein the crystallization of the material takes place in the free fall of e.g. a dripped-in mass.

Nowadays, prilling is mostly used only for the production of low-density ammonium nitrate for use as ANFO (ammonium nitrate fuel oil, an explosive) or for the production of ammonium-nitrate-containing fertilizers, as this method has drawbacks compared to granulation for environmental reasons, but also with respect to hardness, particle size and shelf life.

Fluidized bed spray granulation uses a flow, for example of hot air, in order to fluidize a particle bed. In this case, for example, a solution to be granulated is sprayed from the upper side or underside via nozzles, causing finely distributed droplets to be applied to the fluidized and thoroughly mixed particles. This air flow leads to solidification of the applied components, wherein the water content evaporates and is largely discharged via the exhaust gas stream.

In a pugmill, impact arms positioned on two shafts rotating in opposite directions produce a fluidized particle bed. Into this particle bed, for example, the melt of a substance or substance mixture to be granulated is introduced, mixed by means of the rotating impact arms and conveyed through the granulator, resulting in a granulated product.

The high quality requirements and the necessity of complying with various product parameters thus result in specific plant dimensions, which disclose fertilizer processes as individual production plants. The accompanying investments for fertilizer producers reach considerable orders of magnitude, which justifies the need for processes with as widely varied a product portfolio as possible. By means of these multipurpose plants, the resulting product is adapted to the respective needs within the same production facility. The added benefit for the producers is obvious: increased flexibility, comparatively reduced investment costs, low personnel expenses, reduced space requirements, etc.

In order to produce a fertilizer containing ammonium nitrate, a filler in the form of limestone, dolomite or magnesite is added during granulation. Here, limestone refers to a material consisting predominantly of CaCO₃. Dolomite refers to a material consisting predominantly of CaMg(CO₃)₂. Magnesite refers to a material consisting predominantly of MgCO₃. In addition, the filler materials may comprise further components, e.g. silicates, aluminates, aluminosilicates, etc., in small amounts (less than 25 wt. %, preferably less than 10 wt. % and particularly preferably less than 5 wt. %). Basically, this filler performs three functions:
(i) reduction of the ammonium nitrate content to 80% and thus prevention of an explosive product in the case of calcium ammonium nitrate (CAN);
(ii) increasing the pH and thus preventing hyperacidity of the soil (in addition, this also enhances the safety of handling the product);
(iii) the action of the magnesium and calcium salts as plant nutrients.

In contrast to the two methods mentioned above, so-called “pugmill” granulation offers many advantages, for example:
(i) it makes it possible to produce fertilizers with widely varying nitrogen contents (between 22 and 33.5% total nitrogen) and to switch between calcium ammonium nitrate (CAN) and ammonium nitrate (AN) fertilizers without problems in the shortest possible time during operation;
(ii) it is considered to be tolerant with respect to the filler materials (fillers) used (for example, dolomite versus limestone);
(iii) it provides a high degree of inherent safety because of the relatively low concentration of the ammonium nitrate melt used and the lower temperature therefore required.

The tolerance with respect to the filler material makes it possible to use a wide variety of limestones or also dolomites of differing origin and composition. Preferably, however, the molar Ca/Mg ratio should be in a range significantly above 1. In fact, this simplified observation is based on the fact that the available Ca and Mg species are exclusively in the form of carbonates (calcite, magnesite and/or dolomite). Depending on the required AN or total nitrogen concentration of the product, however, it may be necessary to adjust the calcite concentration. Generally speaking, in order to achieve granulation, a higher calcite concentration is required with increasing nitrogen concentration of the product. This problem can be solved by mixing in filler materials (fillers) with a higher calcite content, such as e.g. adding limestone to dolomite.

Known fertilizer production methods by means of drum granulation, prilling, or a pugmill offer only a limited number of degrees of freedom when it comes to adapting the basic process conditions to a new product. For example, it is not readily possible to adjust the drum of a drum granulation unit to different residence times with an identical temperature profile for varying products. Moreover, for example, targeted imprinting of a temperature profile for crystallization in a prilling tower is possible only within a very narrow range for a given dimensioning. In addition, for example in a pugmill process with a given throughput and product, the residence time cannot be readily varied by removing/adding impact arms. These processes are thus subject to fundamental limitations.

In fluidized bed spray granulation, for example, one requires a specified amount of fluid air, a specified pressure loss over the perforated bottom plate and the particle bed, a defined temperature, and a specified spray arrangement in order to produce varying products on a production apparatus.

A fertilizer is known from Chinese Patent CN 103172453 A which has a layer structure with a water-soluble granulate core that is coated with a first layer of a powdery, slowly-released material of calcined dolomite powder, wherein a second layer of one or more fertilizer substances is then applied to the granulate core selected from the group comprising monoammonium phosphate, diammonium phosphate, potassium sulfate and potassium chloride, as well as an additive selected from the group consisting of calcium magnesium phosphate fertilizers, calcium magnesium phosphate potassium fertilizers or a powdery, inorganic substance that slowly releases the fertilizer. In this fertilizer, the water-soluble granules may include ammonium nitrate, among other substances. The fertilizer described in this document has a specific property, namely the sustained release (so-called “slow release”) of the fertilizer substances, which is intended to allow the plants to be supplied with nutrients over a longer period of time, for example throughout the entire growing period. Washing out of the nutrients contained in the fertilizer is hindered by certain substances, thus allowing a long-term fertilizer effect to be achieved. In addition, this known fertilizer contains phosphates as an essential component.

A method is known from GB 828,430 A for producing so-called lime nitrogen (calcium cyanamide) [Ca(CN)₂], which is also used as a fertilizer, from ammonia, calcium oxide, and carbon monoxide. In this production method, limestone is first calcined at a temperature of between 850° C. and 950° C., and a gas stream of nitrogen, carbon monoxide and ammonia is then allowed to flow over the calcined limestone in order to obtain calcium cyanamide with 90% purity. In this method, the calcination allows activation of the limestone—i.e. conversion to CaO, which is used for the subsequent reaction with ammonia and carbon monoxide.

The use of calcined dolomite in fertilizer granulates is known in principle from U.S. Pat. No. 2,727,809 A. However, this is a fertilizer that contains phosphates to 50% or 60% and thus consists predominately of potash, and also contains ammonium sulfate. Ammonium nitrate is mentioned only as one of many further ingredients of the fertilizer. The document contains no mention of adjusting in a targeted manner the reactivity of the filler material by means of its degree of calcination.

In the document by P. Kamermann et al., “The Uhde Pugmill Granulation,” presented at the 2006 IFA Technical Symposium in Vilnius, Lithuania on Apr. 25-28, 2006, the method of so-called pugmill granulation is described. Combinations of dolomite and calcite with ammonium nitrate are described, but this document contains no disclosure on achieving a defined degree of calcination of the calcium minerals. This document only points out the necessity of selecting a filler material having suitable reactivity. Although this document also mentions contents of CaO and MgO, this refers only to formal wording that derives from an analysis for determining the Ca or Mg content of the filler material. In said analysis method, the contents of Ca and Mg are determined and formally indicated as the oxides thereof (CaO and MgO).

In RU 2015120152 A, a fertilizer granulate based on ammonium nitrate is described to which, as an additive, a magnesium oxide powder is added that has been previously obtained by heating with natural magnesite. The use of MgO is intended to cause a reduction in Ca(NO₃)₂ and Mg(NO₃)₂, which is to improve the hygroscopic characteristics of the product. These indications are doubtful because it is rather to be assumed that only the formation of Ca(NO₃)₂ is suppressed, while MgO would further react to Mg(NO₃)₂.

The object of the present invention is to provide a method for producing a fertilizer granulate with the features of the species initially mentioned in which it is ensured that the filler material used in addition to the active component(s) shows sufficient reactivity.

The above object is achieved by means of a method for producing a fertilizer granulate of the above-mentioned type having the features of claim 1.

According to the invention, it is provided that the reactivity of the filler material is adjusted in a targeted manner by means of its degree of calcination, wherein a filler material selected from the group comprising calcined limestone, partially calcined limestone, calcined dolomite and partially calcined dolomite is added to the fertilizer granulate.

The object of the present invention is to provide a suitable “reaction window” of the filler material in order to produce a product that is granulatable to the degree desired. This results in the particular advantage of allowing the reactivity even of normally “unusable” filler material, because it is largely unreactive, such as e.g. dolomite, to be adjusted in a targetable manner.

The present invention relates in particular to fertilizer granulates in which the main component is ammonium nitrate or calcium ammonium nitrate or optionally a mixture of these two substances. The term “main component” is understood herein to mean that the fertilizer granulate comprises 50% or more of this substance.

Preferably, if the fertilizer granulate is based on ammonium nitrate (AN), it comprises at least 80% ammonium nitrate, preferably at least 90% ammonium nitrate.

Moreover, at least one filler material selected from the group comprising calcined limestone, partially calcined limestone, calcined dolomite and partially calcined dolomite is added to the fertilizer granulate according to the invention, if it is based on ammonium nitrate, in a total amount of up to 5 wt. %, particularly preferably in a total amount of up to 4 wt. %, in order to adjust the degree of calcination in a targeted manner.

In addition, the fertilizer granulate according to the invention, if it is based on ammonium nitrate, can comprise further additives, in particular acid-releasing or sulfate-containing additives, in a total amount of up to 10 wt. %, preferably in a total amount of up to 7.5 wt. %, particularly preferably in a total amount of up to 5 wt. %.

Preferably, the fertilizer granulate according to the invention, if it is based on calcium ammonium nitrate (CAN), comprises a filler material selected from the group comprising calcined limestone, partially calcined limestone, calcined dolomite, partially calcined dolomite, calcined magnesite and partially calcined magnesite in a total amount of up to 40 wt. %, preferably in a total amount of up to 30 wt. %, particularly preferably in a total amount of up to 25 wt. %.

If calcium ammonium nitrate forms the main component of the fertilizer granulate according to the invention, it preferably comprises at least 60 wt. %, in particular at least 70 wt. %, particularly preferably at least 75 wt. % calcium ammonium nitrate. The remainder up to 100 wt. % can in this variant optionally consist of the above-mentioned fillers and/or additives.

An essential advantage of the present invention is that the feasibility of CAN/AN granulation largely depends on the reactivity of the original filler material to be used. Instead of determining a suitable material based on its respective reactivity by preselection, as was previously the case, virtually any filler material selected from minerals ranging from dolomite and limestone-containing dolomite to limestone or magnesite can be used, as the reactivity can be adjusted largely as desired by means of the idea underlying the invention, namely (partial) pre-calcination.

In the method according to the invention, the granulation preferably takes place in a pugmill granulator. In this technology, the granules are built up in the pugmill granulator in such a way that a melt of the fertilizer substances, for example ammonium nitrate or calcium ammonium nitrate, and a filler material, in particular limestone and/or dolomite, is continuously applied to the granules. These are preferably subjected to a recycling process and thus built up layer by layer until the desired particle size is reached so that the granules can then be discharged via a sieve as correctly-sized granules. Undersized granules can be returned to the granulator via a sieve. Oversized granules can for example first be finely crushed and then fed to the granulator.

An important criterion for achieving required particle sizes—according to industrial standards, 93-95% between 2 and 4 mm—and thus granulatability is the reactivity of the filler material (also referred to as filler). The reactivity of the filler material is shown in the reaction of the carbonates of calcite, dolomite or magnesite with ammonium nitrate according to reaction equation (1) below. The reactivity of the filler material drops with decreasing calcite content, with the result that in the case of pure dolomite (double salt of the formula CaMg(CO₃)), the filler material shows virtually no reactivity. To a certain extent, this lack of reactivity can be compensated for by increasing the temperature or the residence time (reaction kinetics) in the granulator. At extremely low calcite contents, however, even these measures are unsuccessful. When ammonium nitrate is granulated, this can result in extreme cases in the exclusive production of undersized granules, with the process breaking down because of the continuously increasing recycle stream.

The present invention therefore proposes previous calcination, or at least partial calcination, of at least a portion of the filler material. However, the calcination of dolomite takes place via a two-stage process in which, as described in reaction equation (1), the magnesium component of the dolomite is first calcined to MgO, and in partial calcination, magnesium oxide and calcite (CaCO₃) are thus produced.

CaMg(CO₃)₂→CaCO₃+MgO+CO₂ (1)

The dolomite pretreated in this manner shows sharply increased reactivity, which in the method according to the invention can be adjusted virtually as desired by targeted control of the calcination.

In pugmill granulation, the filler material is directly fed into the granulator or added in an upstream mixer to the mixture of granules and ammonium nitrate melt or only to the melt.

In fluidized bed granulation and prilling, the filler material is preferably added to the feed material stream.

The calcite content of the filler material is therefore important because calcite (CaCO₃) decisively reacts with ammonium nitrate in the granulator according to the following chemical mechanism:

CaCO₃+2NH₄NO₃→Ca(NO₃)₂+2NH₃+CO₂+H₂O (2)

In addition to this, the calcite can be reacted with free acids that may be present (e.g. due to additives) and thus buffer the acids.

CaCO₃+2H₃⁺→Ca²⁺+3H₂O+CO₂ (3)

If (partially) calcined filler material is used, the oxides may also be present, which react with the ammonium nitrate according to the following equation:

CaO+2NH₄NO₃→Ca(NO₃)₂+2NH₃+H₂O (4)

The above-mentioned equations 2 to 4 also apply to the same extent for the corresponding magnesium species (magnesite and magnesium oxide).

In both cases, carbon dioxide is produced, and in reaction (2) additionally ammonia. Both substances are released in the granulator as gaseous components, and as described above, increase the pH of the granules. Here, the reaction of the dolomite with ammonium nitrate and free acids plays a subordinate role. It is this very reactivity according to equation (2) (and to a minor extent also equation (3)) that has a decisive influence on granulatability, and thus on the particle size distribution and pH of the product. The pH of the product after the granulator usually serves as an indicator/measure of granulatability and is thus an indirect but not always correct indicator of the reactivity according to equation (2) (or equation (3)).

On the one hand, the calcium nitrate or magnesium nitrate produced by reaction of the ammonium nitrate with the filler material (equation (2)) has the above-mentioned positive effect on the end product of improving granulatability, but on the other hand, if the concentrations are excessively high, this can result in deterioration of shelf life due to the hygroscopic characteristics. In order to counteract this, one adds e.g. sulfate-containing additives, among other substances, and/or the product is provided with a coating. The sulfate also has the action of allowing calcium sulfate to form, which in turn has significantly weaker hygroscopic characteristics than the calcium nitrate, thus leading to improved shelf life.

In general, the reactivity of the filler material according to equation (2) must be higher with increasing total nitrogen concentration. In the case of the same filler material but variable operation (total N 22-34 wt. %), this can lead to the conflict that either the filler has a Ca(NO₃)₂ content that is too high, resulting in poor shelf life, and as a side effect, an excessively low N content (cf. equation (2)) (the filler is too reactive) or that no or only poor granulatability (i.e., an excessively narrow particle size spectrum) is achieved (the filler is unreactive). In the worst case, both of these events can lead to breakdown of the process and thus production.

In order to get around the above-described problems, preferably at least a proportion of the filler material is placed in a suitable calcining oven according to the present method and heated until a suitable degree of calcination and thus also a suitable reactivity is achieved. In this manner, even using an originally unreactive filler material such as e.g. dolomite, the reactivity necessary for each process condition can be adjusted.

The degree of calcination is defined here as the ratio of the mineralogical composition of CaCO₃:CaO:CaMg(CO₃)₂:MgCO₃:MgO.

Optionally, a partial amount of (partially) calcined fillers can also be mixed in a determined ratio with untreated filler material.

For example, it would be conceivable to mix pure, unreactive dolomite with a partial amount of (partially) calcined and thus “reactive dolomite” in any desired mixing ratio and thus to achieve a well-defined reactivity.

The determination and adjustment of the calcination temperature suitable for this method can take place by means of suitable analytical methods, e.g. thermogravimetry or a similar method.

The adjustment of the desired degree of calcination can then be confirmed for example by means of (quantitative) powder diffractometry and/or quantitative carbonate determination and/or ignition loss or a combination of the above-mentioned methods and determination of the associated reactivity.

Calcium and magnesium contents can be determined by means of suitable analysis methods such as e.g. x-ray fluorescence spectroscopy, atomic absorption spectrometry (AAS), inductively coupled plasma (ICP), and complexometric titration.

The total reactivity of the filler material is determined by heating a defined amount of ammonium nitrate to a defined temperature (until melting) and adding a defined amount of the desired filler material (and optionally additives). The reaction melt is then allowed to stand for a defined time at this temperature and then cooled. The Ca(NO₃)₂ and/or Mg(NO₃)₂ produced according to equations 2 to 4 is then extracted from the cooled melt using a suitable solvent and determined by means of complexometric titration. The total reactivity (R_{filler}) according to equation 5 thus describes the molar ratio in percent of reacted to unreacted filler material.

$${R}_{filler} = \frac{{n}_{Ca ; titr} + {n}_{Mg ; titr}}{{n}_{Ca ; total} + {n}_{Mg ; total}} \cdot 100 mol \% \qquad ( 5 )$$

A further desirable side effect is that this pretreatment of the dolomite (or limestone) makes it oxidize undesirable organic components, thus allowing them to be virtually completely removed. Dolomites and limestones that are loaded with high organic contents of carbon and would therefore otherwise be unusable for safety reasons are thus useable in the context of the invention.

According to a preferred improvement of the invention, the calcination takes place at a temperature of less than 800° C., preferably at a temperature of less than 760° C. For example, temperatures in the range of approx. 720° C. to approx. 760° C. can be selected.

According to a preferred improvement of the invention, the degree of calcination is determined via the temperature and/or the duration of calcination of the filler material. In principle, the higher the temperature, the higher the degree of calcination. Moreover, the degree of calcination generally increases with the duration of calcination, wherein, however, the calcination process is as a rule completed after a certain duration, so that further calcination no longer leads to a substantial increase in the reactivity of the calcined filler material.

For example, the calcination can take place in particular in use of the above-mentioned preferred temperature ranges for a duration of approx. 2 min to 24 h, preferably for a duration of approx. 30 min up to approx. 4 h. Naturally, the duration of calcination can also depend on the type of mineral used and the calcination process, independently of the calcination temperature.

According to a preferred improvement of the invention, dolomite (CaMg(CO₃)₂) is used as a filler material, wherein the duration of calcination of the dolomite, and connected thereto, its degree of calcination and its reactivity, which increases with the duration of calcination, can be controlled via for example the content of carbonates, which is determinable by mineralogical analysis, and the corresponding oxides. In the (partial) calcination of dolomite, in a first stage, the magnesium component of the dolomite is (partially) converted to magnesium oxide and calcite (CaCO₃) is released, so that the magnesium oxide content and the proportion of calcite increase as calcination progresses. It is not until a second stage (on increasing the temperature) that CaCO₃ is calcined to CaO due to the partial calcination of the dolomite present. One can thus proceed for example in such a way that the filler material is calcined until a proportion of the originally contained dolomite has been converted to calcite (CaCO₃) such that a calcite content in the filler material of at least approx. 20 wt. %, preferably of at least approx. 40 wt. % is achieved.

According to a preferred improvement of the invention, the original calcite content (CaCO₃ content) of the mineral used can serve as a further parameter for the degree of calcination and the required duration of calcination of the filler material, because if this content is already comparatively high prior to calcination, the filler material is accordingly more reactive and need only be calcined to a lesser extent in order to achieve a desired degree of reactivity. The original calcite content of the mineral can be determined by means of suitable analysis methods such as e.g. powder diffractometry.

According to a preferred improvement of the method according to the invention, the reactivity of the filler material used can also be controlled by on the one hand using a proportion of uncalcined dolomite as a filler material and in addition using a proportion of calcined reactive dolomite as a filler material. As these proportions of less reactive untreated dolomite and more reactive calcined dolomite can be mixed virtually as desired, this for example provides the advantage that originally less reactive dolomite rock can be used by increasing the proportion of reactive calcined dolomite. In this manner, independently of the available starting material, one can always adjust a desired total reactivity of the total amount of filler material used in the fertilizer.

For example, if a mixture of unreactive and partially calcined dolomite is used as a filler material, it can e.g. be advantageous to carry out 50% calcination of the partially calcined proportion of the filler material, i.e. based on a complete calcination, 50% of the MgCa(CO₃)₂ is converted to MgO and CaCO₃, as MgO and calcite (CaCO₃) are first produced in calcination.

For example, according to a preferred improvement of the invention, if a dolomite is used as a part of the filler material that has been calcined at a suitable temperature for such a duration, it is recommended that the filler material has a total reactivity of at least 2 mol %, preferably of at least 20 mol %.

According to a possible variant of the invention, a mixture of limestone and dolomite can also be used as a filler material, wherein the limestone has a higher calcite content and thus a higher reactivity, so that in this variant of the method, the total content of calcite in the filler material can also be determined in a targeted manner. According to this variant, only the respective proportions of the minerals used are mixed in such a ratio that one obtains a desired total content of calcite in the filler material and the total reactivity of the filler material associated therewith.

A further object of the present invention is a fertilizer granulate comprising ammonium nitrate or calcium ammonium nitrate as its main component and also at least a proportion of an at least partially calcined limestone and/or dolomite as a filler material, wherein the reactivity of the filler material has been adjusted by means of its degree of calcination according to the method described above.

The present invention is explained in further detail below by means of exemplary embodiments with reference to the attached drawings. The figures show the following:

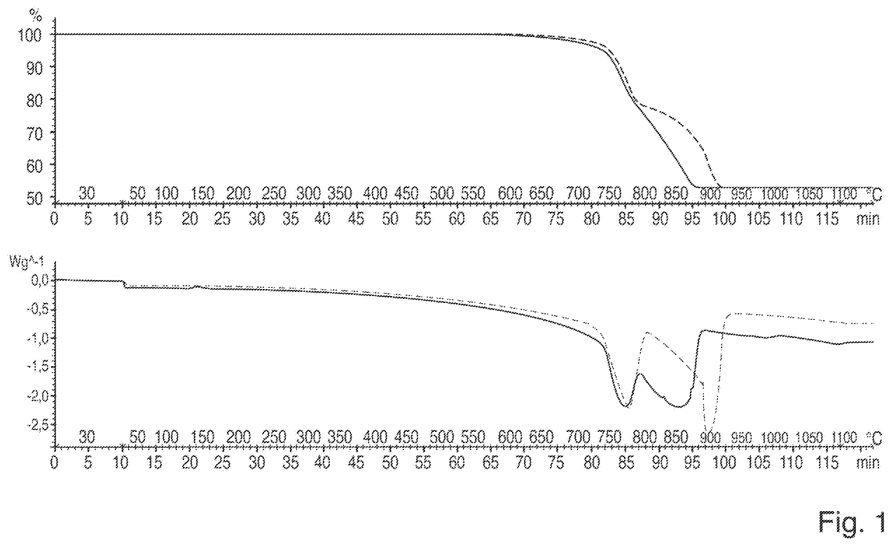

FIG. 1 shows a graphic representation of a thermogravimetric analysis of a two-stage calcining process;

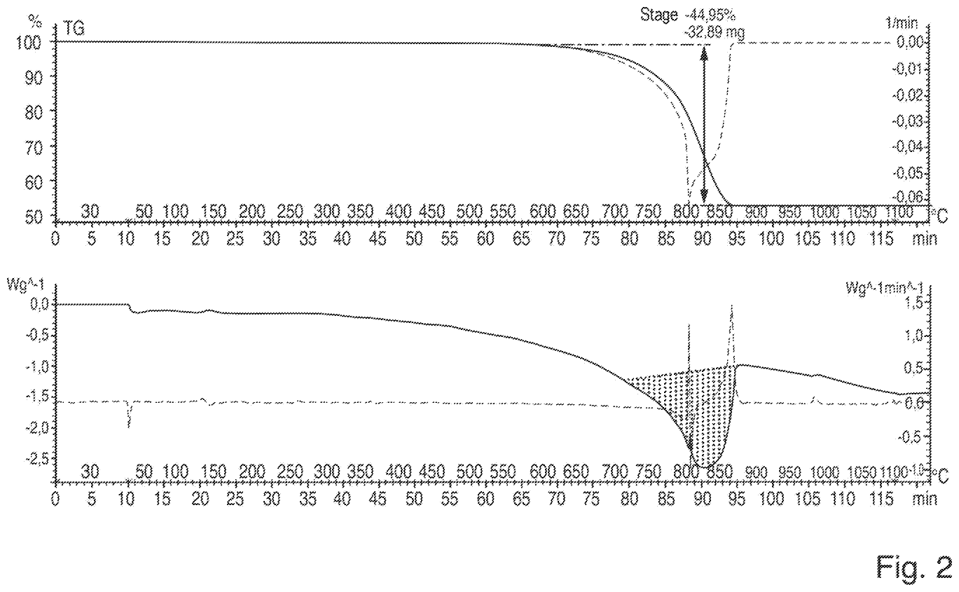

FIG. 2 shows a graphic representation of a thermogravimetric analysis of a dolomite under “atmospheric” conditions; and

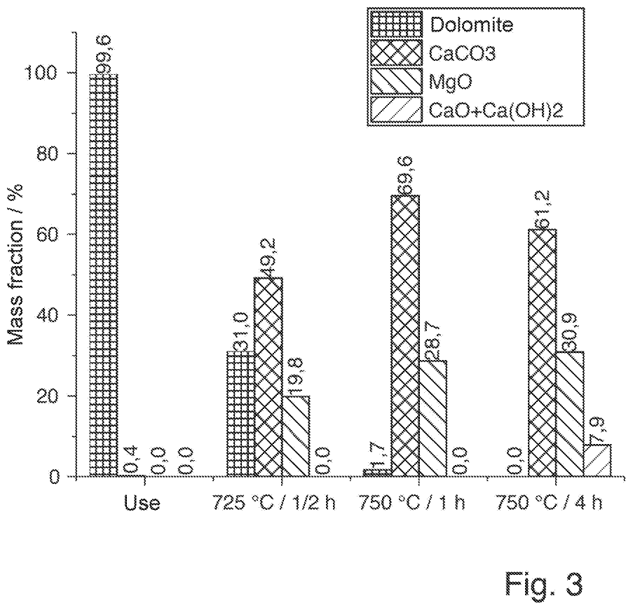

FIG. 3 shows a graphic representation of the contents of dolomite, calcite, periclase and calcium oxide (and also of the hydration product calcium hydroxide) as a function of the calcination conditions.

### EXAMPLE 1

Dolomites “deacidify” in the calcining process via a two-stage process, wherein in a first step, essentially the “MgCO₃” portion of the crystal lattice first deacidifies, after which MgO and CaCO₃ are produced. In a second step, the CaCO₃ then decomposes, resulting in completely calcined dolomite in the oxide forms MgO and CaO. In FIG. 1, this process is graphically represented based on a thermogravimetric analysis. In the upper figure, on the ordinate, the mass of a sample is shown with respect to the mass at the beginning of the analysis, which was carried out in a crucible. The curve therefore begins at 100%. It can be seen that after a certain duration, on heating of the sample to a temperature of approx. 700° C., the decomposition process begins and CO₂ escapes, causing the mass of the remaining sample to decrease. Two curves were recorded in order to visualize the influence of the CO₂ partial pressure in the crucible, wherein one of the curves was recorded with a crucible not having a lid (atmospheric condition) and the other was recorded with a lid in place (in a vacuum; increased CO₂ partial pressure). As expected, in the case of the sample having a lid, the process is slowed by the higher CO₂ partial pressure and thus shifted to higher temperatures. Moreover, it can be seen that an increase in the CO₂ partial pressure leads to better separation of the two calcination stages. In this manner, the calcination can be controlled by adjusting the CO₂ partial pressure as a further parameter.

In the lower area of FIG. 1, two further curves relating to this experiment are shown, wherein the heat flow in W/g is shown on the ordinate and the duration of the experiment and the increasing temperature are shown on the abscissa, wherein heating was carried out beginning at room temperature. It can be seen that after a heating time of approx. 75 min, a temperature of approx. 700° C. was reached, at which point the heat flow increases sharply (increase in negative heat flow, i.e. increase in the endothermal range), as the decomposition of the carbonates is an endothermal process in which heat is consumed.

In this lower area, it can be clearly seen that the decomposition takes place in two stages, with a first maximum at approx. 780° C. and a second maximum at approx. 860° C., wherein these maxima are displaced toward the second recorded curve, which again was recorded with a crucible having a lid, because of the higher partial pressure of CO₂ corresponding to higher temperatures.

FIG. 2 shows a further thermogravimetric analysis of a dolomite under atmospheric conditions, wherein it can be seen here that at low CO₂ partial pressure, the two deacidification stages can merge into one another, for which reason the calcination step is preferably carried out under a CO₂ atmosphere.

### EXAMPLE 2

Different degrees of calcination were produced for a dolomite based on the results of the thermogravimetric analysis, and the composition was first investigated by means of x-ray fluorescence analysis (RFA) and powder diffractometry (XRD). It was found that depending on the calcination duration and temperature, it is possible to adjust the composition with respect to dolomite, calcite and magnesium oxide (as well as calcium oxide, and as its hydration product, calcium hydroxide) as desired.

Table 1 below shows the result of a quantitative powder diffractometry analysis (XRD analysis) of a dolomite sample in the original state and after various degrees of calcination.

TABLE 1
Mineralogische Analyse

| | | | Dolomit | Dolomit | Dolomit |
|---|---|---|---|---|---|
| | | | 725° C., | 750° C., | 750° C., |
| Mineral | | Dolomit | 0.5 h | 1 h | 4 h |
| % Dolomite | CaMg(CO₃)₂ | 99.6 | 31.0 | 1.7 | 0.0 |
| % Calcite | CaCO₃ | 0.4 | 49.2 | 69.6 | 61.2 |
| % Quartz | SiO₂ | 0.0 | 0.0 | 0.0 | 0.0 |
| % Periclase | MgO | 0.0 | 19.8 | 28.7 | 30.9 |
| % Brucite | Mg(OH)₂ | 0.0 | 0.0 | 0.0 | 0.0 |
| % Lime | CaO | 0.0 | 0.0 | 0.0 | 3.4 |
| % | Ca(OH)₂ | 0.0 | 0.0 | 0.0 | 4.5 |
| Portlandite | | | | | |

| | | | | |
|---|---|---|---|---|
| % Summe | 100.0 | 100.0 | 100.0 | 100.0 |

Key: Mineralogical analysis
Dolomite
Total
X-ray fluorescence analysis (RFA) shows that as expected, the chemical composition (within the measurement uncertainty of the method) remains identical as a percentage of the change in ignition loss (due to the prior deacidification by partial calcination) (cf. CaO/MgO ratio).

TABLE 2
RFA of the dolomite sample in the original
state and after varying degrees of calcination.
Chemische Analyse

| | | Dolomit | Dolomit | Dolomit |
|---|---|---|---|---|
| | | 725° C., | 750° C., | 750° C., |
| Bezeichnung | Dolomit | 0.5 h | 1 h | 4 h |
| % GV (1050° C.) | 46.78 | 36.19 | 32.34 | 27.37 |
| % CaO | 31.67 | 38.50 | 41.38 | 43.50 |
| % MgO | 20.76 | 24.63 | 25.59 | 28.44 |
| % Rest | 0.79 | 0.68 | 0.69 | 0.69 |
| % Summe | 100.00 | 100.00 | 100.00 | 100.00 |
| CaO/MgO-Verh. (n/n) | 1.096 | 1.123 | 1.162 | 1.099 |

Key: Chemical analysis
Designation
Residue
Total
Dolomite
Ratio

### EXAMPLE 3

For the dolomite samples of varying degrees of calcination listed in the above tables, the radioactivity values were determined according to equation 5 and the method described in the text. Taking into account the total amounts of Ca and Mg present in the filler material, the size of the reacted partial amount is determined according to equations 2 to 4. The results are shown below in Table 3 with respect on the one hand to the reacted partial amount of Ca (R_{Ca}) or Mg (R_{Mg}) and also as total reactivity (R_{ges}) based on the total amount of the sum of Ca and Mg given in mol %. For the dolomite calcined for 4 h, no usable results were obtained due to the extremely intense reactivity. However, it can be assumed based on estimates and comparison with the sample calcined for 1 h that the total reactivity will be significantly greater than 50 mol %.

TABLE 3
Reactivities of the dolomite sample in the original
state and after varying degrees of calcination.
Reaktivität nach Gleichung 1 bis 3

| | | | Dolomit | Dolomit | Dolomit |
|---|---|---|---|---|---|
| | | | 725° C., | 750° C., | 750° C., |
| Reaktivität | | Dolomit | 0.5 h | 1 h | 4 h |
| R_{Mg} | mol-% | 3.9 | 48.4 | 83.4 | n.a. |
| R_{Ca} | mol-% | 1.7 | 10.1 | 20.8 | n.a. |
| R_{ges} | mol-% | 2.8 | 28.2 | 49.7 | n.a. |

Key: Reactivity according to equations 1 to 3
Reactivity
Dolomite

### EXAMPLE 4

For a mixture of three parts by mass of untreated dolomite and one part by mass of dolomite calcined at 725° C. for 0.5 h, the reactivity within the meaning of equation 5 was investigated. The total reactivity was determined at R_{ges}=18.4 mol % (cf. R_{ges}=2.8 mol % or 28.2 mol %).

This example shows that targeted reactivity levels are also adjustable by means of defined mixing ratios.

FIG. 3 shows the respective content of a rock having an initial dolomite content of 99.6% as a function of different calcination conditions with respect to treatment temperature and treatment duration. It can be seen that the percentage by mass of dolomite is decreased by the treatment, and that of calcite increased. After 1 h treatment at 750° C., the calcite content is higher than in only 30 min treatment at a lower temperature of 725° C. After 4 h treatment at 750° C., no more dolomite is present, and the proportion of calcium oxide and its hydration product calcium hydroxide has increased. It can also be seen that the magnesium oxide content increases with increasing temperature and treatment duration.

1.-24. (canceled)

25. A method for producing a fertilizer granulate comprising an ammonium salt and a filler material, the method comprising:
at least partially calcining limestone or dolomite as the filler material prior to use in the fertilizer granulate;
adjusting a reactivity of the filler material in a targeted manner by way of degree of calcination of the filler material; and
adding to the fertilizer granulate the filler material, which filler material comprises at least one of calcined limestone, partially calcined limestone, calcined dolomite, or partially calcined dolomite in a total amount of up to 10% by weight.

26. The method of claim 25 wherein the fertilizer granulate comprises ammonium nitrate as a primary component.

27. The method of claim 26 wherein the fertilizer granulate comprises at least 80% ammonium nitrate.

28. The method of claim 26 wherein the filler material is added to the fertilizer granulate in a total amount of up to 5% by weight.

29. The method of claim 25 wherein the fertilizer granulate comprises acid-releasing additives or sulfate-containing additives in a total amount of up to 10% by weight.

30. The method of claim 25 wherein the fertilizer granulate comprises calcium ammonium nitrate as a primary component.

31. The method of claim 30 wherein the filler material comprises calcined magnesite or partially calcined magnesite in a total amount of up to 40% by weight.

32. The method of claim 30 wherein the fertilizer granulate comprises at least 60% by weight calcium ammonium nitrate.

33. The method of claim 25 comprising heating at least a portion of the filler material in a calcining oven.

34. The method of claim 33 wherein the at least the portion of the filler material is heated in the calcining oven to a degree of calcination, the method further comprising determining the degree of calcination via an analytical method.

35. The method of claim 33 wherein the at least the portion of the filler material is heated in the calcining oven to achieve a degree of calcination and the reactivity of the filler material, wherein after or during the calcination and prior to use of the filler material the reactivity of the filler material connected with the degree of calcination of the filler material is determined via an analytical method.

36. The method of claim 35 comprising determining the reactivity of the filler material by way of its reaction with a primary component of the fertilizer granulate.

37. The method of claim 25 wherein the calcination occurs at a temperature of less than 800° C.

38. The method of claim 25 wherein a degree to which the filler material is calcined is determined by determining a calcite proportion by way of x-ray diffractometry.

39. The method of claim 25 wherein a degree to which the filler material is calcined is achieved via a temperature and/or a duration of calcination.

40. The method of claim 29 wherein the duration of the calcination is between 2 minutes and 24 hours.

41. The method of claim 25 wherein dolomite is used as the filler material, the dolomite being calcined until such a proportion of calcium originally contained in the dolomite has been converted to calcite such that a calcite proportion in the filler material is at least approximately 20% by weight.

42. The method of claim 25 comprising selecting a degree to which the filler material is calcined based on calcite content of the filler material.

43. The method of claim 25 wherein the filler material comprises uncalcined dolomite and calcined dolomite.

44. The method of claim 43 wherein the reactivity of the filler material is adjusted via a ratio of uncalcined dolomite to calcined dolomite in the filler material.

45. The method of claim 25 wherein the filler material comprises dolomite that has been calcined at a temperature for a duration such that the filler material has a total reactivity of at least 2% mol.

46. The method of claim 25 wherein the filler material comprises a mixture of limestone and dolomite.

47. The method of claim 25 wherein the production of the fertilizer granulate occurs in a pugmill granulator.

48. A fertilizer granulate comprising ammonium nitrate or calcium ammonium nitrate as a primary component and at least a proportion of an at least partially calcined limestone and/or dolomite as a filler material, wherein a reactivity of the filler material has been adjusted in a targeted manner by way of its degree of calcination according to the method of claim 25.

49. A fertilizer granulate comprising ammonium nitrate or calcium ammonium nitrate as a primary component and at least a proportion of an at least partially calcined limestone and/or dolomite as a filler material, wherein a reactivity of the filler material has been adjusted in a targeted manner by way of its degree of calcination.
